(19) United States
(12) Patent Application Publication
(10) Pub. No.: US 2024/0322246 A1
(43) Pub. Date: Sep. 26, 2024

(54) FUNCTIONALIZED PHOSPHINE OXIDES AND FUNCTIONALIZED PHOSPHINE SULFIDES FOR LITHIUM-ION BATTERIES

(71) Applicant: NOHMs Technologies, Inc., Rochester, NY (US)

(72) Inventors: Gabriel Torres, Rochester, NY (US); John Sinicropi, Rochester, NY (US); Surya S. Moganty, Henrietta, NY (US)

(73) Assignee: NOHMs Technologies, Inc., Rochester, NY (US)

(21) Appl. No.: 18/612,292

(22) Filed: Mar. 21, 2024

Related U.S. Application Data
(60) Provisional application No. 63/454,418, filed on Mar. 24, 2023.

(51) Int. Cl. H01M 10/0567; C07F 9/53; H01G 11/06; H01G 11/52; H01G 11/62; H01G 11/64; H01M 10/0525; H01M 10/42

(52) U.S. Cl. CPC H01M 10/0567; C07F 9/5325; H01G 11/06; H01G 11/52; H01G 11/62; H01G 11/64; H01M 10/0525; H01M 10/4235; H01M 2300/0025

(57) ABSTRACT

An electrolyte containing functionalized phosphine oxides or phosphine sulfides suitable for use in electrochemical energy storage devices useful for reducing battery resistance, increasing cycle life, and improving high-temperature performance; and an electrolyte containing the functionalized phosphine oxides or phosphine sulfides suitable for use in electrochemical energy storage devices.

### CROSS-REFERENCE

This application is related to and claims priority to U.S. Provisional Patent Application No. 63/454,416 filed Mar. 24, 2023, which is incorporated herein by reference.

### FIELD

The present disclosure relates to functionalized phosphine oxides and functionalized phosphine sulfides useful for reducing battery resistance, increasing cycle life, and improving high-temperature performance; and an electrolyte containing the functionalized phosphine oxides or functionalized phosphine sulfides suitable for use in electrochemical energy storage devices.

### BACKGROUND

Li-ion batteries are heavily used in consumer electronics, electric vehicles (EVs), as well as energy storage systems (ESS) and smart grids. Recently, Li-ion batteries with voltages above 4.35 V have gained importance because of higher capacity and subsequent energy density benefits. However, the stability of the cathode materials at these potentials reduces due to increased oxidation. This may result in electrochemical oxidation of the material to produce gases, and that can deteriorate the performance of the battery. The cathode active material, which is capable of intercalating/deintercalating lithium ions may dissolve in the non-aqueous electrolyte, resulting in a structural breakdown of the material, and will lead to an increase in the interfacial resistance. These Li-ion batteries are also typically exposed to extreme temperatures during their operation. The SEI (Solid Electrolyte Interface) layer formed on the anode is gradually broken down at high temperatures, and hence leads to more irreversible reaction resulting in capacity loss. Similarly, the CEI (Cathode Electrolyte Interface) will also lose stability at elevated temperatures. These reactions happen on the positive and negative electrode during cycling but are generally more severe at higher temperatures due to faster kinetics. The next generation Li-ion batteries used in consumer electronics, EVs, and ESS will require significant improvements in the electrolyte component relative to the current state-of-the art of Li-ion batteries.

The shuttling of positive and negative ions between the battery electrodes is the main function of the electrolyte. Historically, researchers have focused on developing battery electrodes, and electrolyte development has been limited. Traditional Li-ion batteries used carbonate-based electrolytes with a wide electrochemical window that can transport lithium ions. These electrolytes need functional additives to passivate the anode and form a stable SEI, as well as novel additives for stabilizing the cathode. At the same time, there is a need to design and develop compounds that allow stable and safe cycling of high voltage, high energy Li-ion batteries.

As the industry moves towards higher energy cathode materials for higher energy batteries, stable, efficient, and safe cycling of batteries in wide voltage windows is necessary. Li-ion battery electrolytes can be tuned based on their applications by addition of different co-solvents and additives. This tunability has enabled the development of different additives for high voltage stability and safety of Li-ion cells.

There have been reports in the literature of how triphenylphosphine oxide can oxidize to form a cathode electrolyte interphase layer to improve the cycle life of lithium-ion cells with high nickel cathode materials (Beltrop et al, Chem. Mater. 2018, 30, 8, 2726-2741). U.S. Pat. No. 9,252,457 discloses various trialkyl phosphine oxides as electrolyte additives to improve the cycle life of lithium-ion cells with silicon alloy anode materials. U.S. Pat. No. 10,629,952 discloses an electrolyte comprising triphenylphosphine oxide to improve the cycle life of lithium-ion cells with niobium-containing anode materials.

Herein, functionalized phosphine oxides and phosphine sulfides are reported as additives for Li-ion batteries. These molecules as electrolyte additives allow for stabilization of the cathode, anode, and the holistic electrolyte system. A cell with this additive in the electrolyte would enable safe, long cycle life, and high energy lithium-ion batteries. Hence, there is a need to incorporate these compounds to improve the performance of lithium-ion batteries.

### SUMMARY

In accordance with an aspect of the present disclosure, there is provided a new class of compounds, and an electrolyte for an electrochemical energy storage device. The electrolyte includes a functionalized phosphine oxide or phosphine sulfide; an aprotic organic solvent system; and a metal salt.

In accordance with another aspect of the present disclosure, there is provided an electrolyte for an electrochemical energy storage device, the electrolyte includes a functionalized phosphine oxide or phosphine sulfide; an aprotic organic solvent system; a metal salt; and at least one additive.

In accordance with another aspect of the present disclosure, there is provided an electrochemical energy storage device, including: a cathode; an anode; a separator and an electrolyte including a functionalized phosphine oxide or phosphine sulfide, an aprotic organic solvent system, and a metal salt.

In accordance with another aspect of the present disclosure, there is provided an electrolyte for an electrochemical energy storage device, the electrolyte includes: a functionalized phosphine oxide or phosphine sulfide; an aprotic organic solvent system; a metal salt; and at least one additional additive, wherein the aprotic organic solvent includes open-chain or cyclic carbonate, carboxylic acid ester, nitrite, ether, sulfone, sulfoxide, ketone, lactone, dioxolane, glyme, crown ether, siloxane, phosphoric acid ester, phosphite, mono- or polyphosphazene or mixtures thereof.

In accordance with another aspect of the present disclosure, there is provided an electrolyte for an electrochemical energy storage device, the electrolyte includes: a functionalized phosphine oxide or phosphine sulfide; an aprotic organic solvent system; a metal salt; and at least one additional additive, wherein the cation of the metal salt is aluminum, magnesium or an alkali metal, such as lithium or sodium.

In accordance with another aspect of the present disclosure, there is provided an electrolyte for an electrochemical energy storage device, the electrolyte includes: a functionalized phosphine oxide or phosphine sulfide; an aprotic organic solvent system; a metal salt; and at least one additional additive, wherein the additive contains a compound containing at least one unsaturated carbon-carbon bond, carboxylic acid anhydride, sulfur-containing compound, phosphorus-containing compounds boron-containing compound, silicon-containing compound or mixtures thereof.

These and other aspects of the present disclosure will become apparent upon a review of the following detailed description and the claims appended thereto.

### BRIEF DESCRIPTION OF THE DRAWINGS

FIG. 1 shows the differential capacity profile of cell formation with the dQ/dV profiles of electrolytes tested in NMC811/Gr cells; and

FIG. 2 is a cycle life plot showing the cycle life characteristics of 150 mAh pouch cells during cycling for charging and discharging.

### DETAILED DESCRIPTION

The disclosed technology relates generally to lithium-ion (Li-ion) battery electrolytes. Particularly, the disclosure is directed towards a functionalized phosphine oxide or phosphine sulfide including substituted phenyl groups, electrolytes containing these materials, and electrochemical energy storage devices containing the electrolytes.

The present disclosure describes a Li-ion battery electrolyte with an electrolyte material that can overcome anode stability challenges in Li-ion batteries. There is a need to find materials that passivate the anode materials in Li-ion batteries to form a stable and robust SEI film. Also, current state-of-the-art Li-ion batteries include cathode materials that are low in nickel content and operate at high voltage or have high nickel content but operate at a low voltage. State-of-the-art electrolytes are tuned towards these conditions, and researchers have recently started focusing on enabling high nickel, high voltage battery cathodes with novel electrolyte formulations. There is a need to develop an electrolyte solution for cycling of Li-ion cells with high voltage, high nickel cathodes. The present technology is based on an innovative component including a functionalized phosphine oxide or phosphine sulfide, that can improve the stability of high-voltage, high-energy cathodes. These electrolyte components form a unique cathode electrolyte interface (CEI) and do not excessively passivate the cathode, when used at low weight loadings. An improved CEI improves the high temperature performance and storage stability, with no effect at room temperature.

In addition, a phosphine sulfide relative to a phosphine oxide is more likely to reduce because sulfur has greater electron withdrawing properties when compared to oxygen. This propensity for reduction results in compounds likely to participate in SEI formation.

In an embodiment, an electrochemical energy storage device electrolyte includes a) an aprotic organic solvent system; b) a metal salt; c) a functionalized phosphine oxide or phosphine sulfide organic material; and d) at least one additional additive.

In an aspect of the disclosure, the functionalized phosphine oxide or phosphine sulfide organic material includes compounds having the molecular structure according to the following formula:

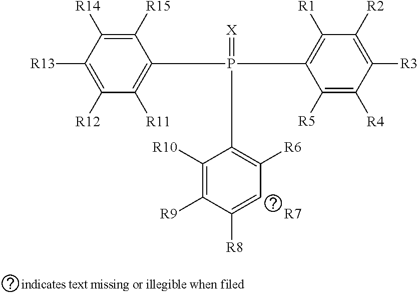

wherein:
X is oxygen or sulfur;
where at least one of R₁ through R₁₅ is independently a C₁-C₁₂ substituted or unsubstituted, saturated or unsaturated alkyl group, or C₆-C₁₄ aryl group, a halogen, an oxygen or sulfur atom, or an oxygen or sulfur atom further bonded to a C₁-C₁₂ substituted or unsubstituted, saturated or unsaturated alkyl group,
   wherein any hydrogen or carbon atom on the R groups can be unsubstituted or can be substituted with an epoxide, halogen, alkyl, alkoxy, perfluorinated alkyl, silyl, siloxy, silane, sulfoxide, amide, azo, ester, carbonyl, nitrile and thioether group or combination thereof.

Specific examples of molecules according to the disclosure are listed below. These examples are only an illustration and are not meant to limit the disclosure of claims to follow.

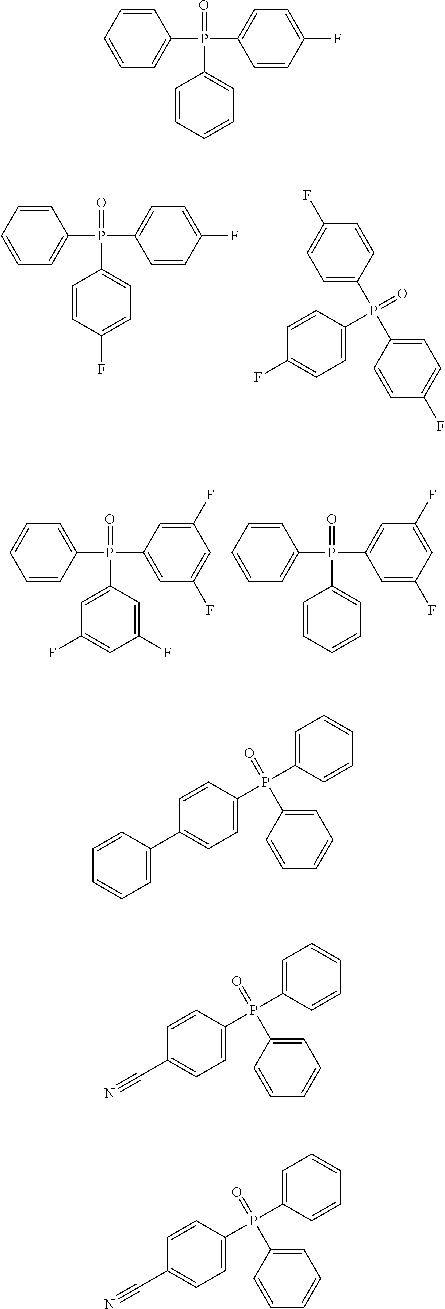

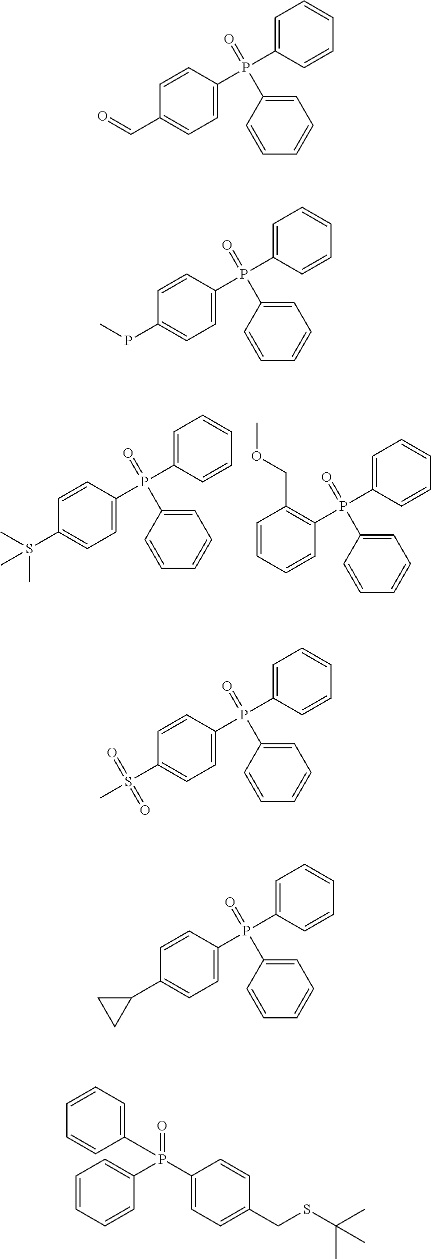

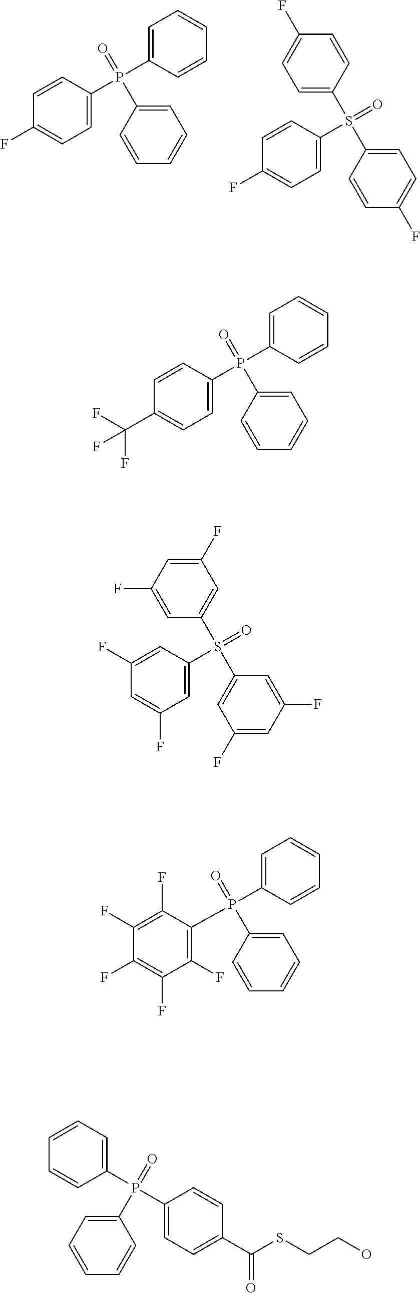

The addition of a functionalized phosphine oxide or phosphine sulfide into the Li-ion battery system allows for the sequestration of metal ions and stabilization of the surface of the cathode. The resulting effect suppresses further oxidative decomposition of the remaining electrolyte components that occurs otherwise in contact with the cathode material. The inclusion of a phosphorus-oxygen or phosphorus-sulfur bond can insure good coordination with high nickel, high energy cathode materials.

The disclosure also includes a method for synthesizing the functionalized phosphine oxide or phosphine sulfide, and the use of such molecules in lithium-ion battery electrolytes. These molecules impart greater stability to the electrolytes and cathodes operating at higher potentials.

In an aspect of the disclosure, the metal salt in the electrolyte is a lithium salt in a range of from 10% to 30% by weight. A variety of lithium salts may be used, including, for example, Li(AsF₆); Li(PF₆); Li(CF₃CO₂); Li(C₂F₅CO₂); Li(CF₃SO₃); Li[N(CP₃SO₂)₂]; Li[C(CF₃SO₂)₃]; Li[N(SO₂C₂F₅)₂]; Li(ClO₄); Li(BF₄); Li(PO₂F₂); Li[PF₂(C₂O₄)₂]; Li[PF₄C₂O₄]; lithium alkyl fluorophosphates; Li[B(C₂O₄)₂]; Li[BF₂C₂O₄].

In an aspect of the disclosure, the electrolyte includes an aprotic organic solvent system selected from open-chain or cyclic carbonate, carboxylic acid ester, nitrite, ether, sulfone, sulfoxide, ketone, lactone, dioxolane, glyme, crown ether, siloxane, phosphoric acid ester, phosphite, mono- or polyphosphazene or mixtures thereof in a range of from 60% to 90% by weight.

Examples of aprotic solvents for generating electrolytes include but are not limited to dimethyl carbonate, ethyl methyl carbonate, diethyl carbonate, methyl propyl carbonate, ethyl propyl carbonate, dipropyl carbonate, propylene carbonate, ethylene carbonate, fluoroethylene carbonate, bis(trifluoroethyl) carbonate, bis(pentafluoropropyl) carbonate, trifluoroethyl methyl carbonate, pentafluoroethyl methyl carbonate, heptafluoropropyl methyl carbonate, perfluorobutyl methyl carbonate, trifluoroethyl ethyl carbonate, pentafluoroethyl ethyl carbonate, heptafluoropropyl ethyl carbonate, perfluorobutyl ethyl carbonate, etc., fluorinated oligomers, methyl propionate, ethyl propionate, butyl propionate, dimethoxyethane, triglyme, dimethylvinylene carbonate, tetraethyleneglycol, dimethyl ether, polyethylene glycols, triphenyl phosphate, tributyl phosphate, hexafluorocyclotriphosphazene, 2-Ethoxy-2,4,4,6,6-pentafluoro-1,3,5,2-5,4-5,6-5 triazatriphosphinine, triphenyl phosphite, sulfolane, dimethyl sulfoxide, ethyl methyl sulfone, ethylvinyl sulfone, allyl methyl sulfone, divinyl sulfone, fluorophenylmethyl sulfone and gamma-butyrolactone.

In an embodiment, the electrolytes include at least one additional additive to protect the electrodes and electrolyte from degradation. Thus, electrolytes of the present technology may include an additive that is reduced or polymerized on the surface of an electrode to form a passivation film on the surface of an electrode.

In an embodiment, the at least one additive is a substituted or unsubstituted linear, branched, or cyclic hydrocarbon including at least one oxygen atom and at least one aryl, alkenyl or alkynyl group. The passivating film formed from such additives may also be formed from a substituted aryl compound or a substituted or unsubstituted heteroaryl compound where the additive includes at least one oxygen atom.

Representative of the at least one additive includes glyoxal bis(diallyl acetal), tetra(ethylene glycol) divinyl ether, 1,3,5-triallyl-1,3,5-triazine-2,4,6(1H,3H,5H)-trione, 1,3,5,7-tetravinyl-1,3,5,7-tetramethylcyclotetrasiloxane, 2,4,6-triallyloxy-1,3,5-triazine, 1,3,5-triacryloylhexahydro-1,3,5-triazine, 1,2-divinyl furoate, 1,3-butadiene carbonate, 1-vinylazetidin-2-one, 1-vinylaziridin-2-one, 1-vinylpiperidin-2-one, 1 vinylpyrrolidin-2-one, 2,4-divinyl-1,3-dioxane, 2-amino-3-vinylcyclohexanone, 2-amino-3-vinylcyclopropanone, 2 amino-4-vinylcyclobutanone, 2-amino-5-vinylcyclopentanone, 2-aryloxy-cyclopropanone, 2-vinyl-[1,2]oxazetidine, 2 vinylaminocyclohexanol, 2-vinylaminocyclopropanone, 2-vinyloxetane, 2-vinyloxy-cyclopropanone, 3-(N-vinylamino)cyclohexanone, 3,5-divinyl furoate, 3-vinylazetidin-2-one, 3 vinylaziridin-2-one, 3-vinylcyclobutanone, 3-vinylcyclopentanone, 3-vinyloxaziridine, 3-vinyloxetane, 3-vinylpyrrolidin-2-one, 2-vinyl-1,3-dioxolane, acrolein diethyl acetal, acrolein dimethyl acetal, 4,4-divinyl-3-dioxolan-2-one, 4-vinyltetrahydropyran, 5-vinylpiperidin-3-one, allylglycidyl ether, butadiene monoxide, butyl-vinyl-ether, dihydropyran-3-one, divinyl butyl carbonate, divinyl carbonate, divinyl crotonate, divinyl ether, divinyl ethylene carbonate, divinyl ethylene silicate, divinyl ethylene sulfate, divinyl ethylene sulfite, divinyl methoxypyrazine, divinyl methylphosphate, divinyl propylene carbonate, ethyl phosphate, methoxy-o-terphenyl, methyl phosphate, oxetan-2-yl-vinylamine, oxiranylvinylamine, vinyl carbonate, vinyl crotonate, vinyl cyclopentanone, vinyl ethyl-2-furoate, vinyl ethylene carbonate, vinyl ethylene silicate, vinyl ethylene sulfate, vinyl ethylene sulfite, vinyl methacrylate, vinyl phosphate, vinyl-2-furoate, vinylcylopropanone, vinylethylene oxide, β-vinyl-γ-butyrolactone or a mixture of any two or more thereof. In some embodiments, the additive may be a cyclotriphosphazene that is substituted with F, alkyloxy, alkenyloxy, aryloxy, methoxy, allyloxy groups, sulfonic acid groups, or combinations thereof. For example, the additive may be a (divinyl)-(methoxy)(trifluoro)cyclotriphosphazene, (trivinyl)(difluoro)(methoxy)cyclotriphosphazene, (vinyl)(methoxy)(tetrafluoro)cyclotriphosphazene, (aryloxy)(tetrafluoro)(methoxy)cyclotriphosphazene, (methylsulfonyl)cyclotriphosphazene, or (diaryloxy)(trifluoro)(methoxy)cyclotriphosphazene compounds or a mixture of two or more such compounds.

In some embodiments the additional additive is a sulfur-containing compound, phosphorus-containing compound, boron-containing compound, silicon-containing compound, fluorine-containing compound, nitrogen-containing compound, compound containing at least one unsaturated carbon-carbon bond, carboxylic acid anhydride or the mixtures thereof. In some embodiments, the additive is vinyl carbonate, vinyl ethylene carbonate, or a mixture of any two or more such compounds. Further, the additive is present in a range of from 0.01% to 10% by weight.

In some embodiments additional additive is a fully or partially halogenated phosphoric acid ester compound, an ionic liquid, or mixtures thereof. The halogenated phosphoric acid ester may include 4-fluorophenyldiphenylphosphate, 3,5-difluorophenyldiphenylphosphate, 4-chlorophenyldiphenylphosphate, trifluorophenylphosphate, heptafluorobutyldiphenylphosphate, trifluoroethyldiphenylphosphate, bis(trifluoroethyl)phenylphosphate, and phenylbis(trifluoroethyl)phosphate. The ionic liquids may include tris(N-ethyl-N-methylpyrrolidinium)thiophosphate bis(trifluoromethylsulfonyl)imide, tris(N-ethyl-N-methylpyrrolidinium) phosphate bis(trifluoromethylsulfonyl)imide, tris(N-ethyl-N-methylpiperidinium)thiophosphate bis(trifluoromethylsulfonyl)imide, tris(N-ethyl-N-methylpiperidinium)phosphate bis(trifluoromethylsulfonyl)imide, N-methyl-trimethylsilylpyrrolidinium bis(trifluoromethylsulfonyl)imide, N-methyl-trimethylsilylpyrrolidinium hexafluorophosphate. Further, the additive is present in a range of 0.01% to 10% by weight.

In another aspect of the disclosure, an electrochemical energy storage device is provided that includes a cathode, an anode and an electrolyte including an ionic liquid as described herein. In an embodiment, the electrochemical energy storage device is a lithium secondary battery. In some embodiments, the secondary battery is a lithium battery, a lithium-ion battery, a lithium-sulfur battery, a lithium-air battery, a sodium ion battery, or a magnesium battery. In some embodiments, the electrochemical energy storage device is an electrochemical cell, such as a capacitor. In some embodiments, the capacitor is an asymmetric capacitor or supercapacitor. In some embodiments, the electrochemical cell is a primary cell. In some embodiments, the primary cell is a lithium/MnO₂ battery or Li/poly(carbon monofluoride) battery.

In an embodiment, a secondary battery is provided including a positive and a negative electrode separated from each other using a porous separator and the electrolyte described herein.

Suitable cathode materials for a secondary battery including the electrolyte described herein include those such as, but not limited to, vanadium oxide, lithium peroxide, sulfur, polysulfide, a lithium carbon monofluoride (also known as LiCFₓ) or mixtures of any two or more thereof, carbon-coated olivine cathodes such as LiFePO₄, lithium metal oxides such LiCoO₂, LiNiO₂, LiNiₓCo_{y}Met_{z}O₂, LiMn_{0.5}Ni_{0.5}O₂, LiMn_{0.1}Co_{0.1}Ni_{0.8}O₂, LiMn_{0.2}Co_{0.2}Ni_{0.6}O₂, LiMn_{0.3}Co_{0.2}Ni_{0.5}O₂, LiMn_{0.33}Co_{0.33}Ni_{0.33}O₂, LiMn₂O₄, LiFeO₂, Li_{1+x′}Ni_{α}Mn_{β}Co_{γ}Met′_{δ}O_{2-z}F_{z′}, or A_{n′}B₂(XO₄)₃, wherein Met is Al, Mg, Ti, B, Ga, Si, Mn or Co; Met′ is Mg, Zn, Al, Ga, B, Zr or Ti; A is Li, Ag, Cu, Na, Mn, Fe, Co, Ni, Cu or Zn; B is Ti, V, Cr, Fe or Zr; X is P, S, Si, W or Mo; and wherein 0≤x≤0.3, 0≤y≤0.5, 0≤z≤0.5, 0≤x′≤0.4, 0≤α≤1, 0≤β≤1, 0≤γ≤1, 0≤δ≤0.4, 0≤z′≤0.4 and 0≤n′≤3. In other embodiments, an olivine cathode has a formula of Li₁₊ₓFe_{1z}Met″_{y}PO₄₋ₘX′ₙ, wherein Met″ is Al, Mg, Ti, B, Ga, Si, Ni, Mn or Co; X is S or F; and wherein 0≤x≤0.3, 0≤y≤0.5, 0≤z≤0.5, 0≤m≤0.5 and 0≤n≤0.5. Suitable anodes include those such as lithium metal, graphitic materials, amorphous carbon, carbon nanotubes, Li₄Ti₅O₁₂, tin alloys, silicon, silicon alloys, intermetallic compounds, or mixtures of any two or more such materials. Suitable graphitic materials include natural graphite, artificial graphite, graphitized meso-carbon microbeads (MCMB) and graphite fibers, as well as any amorphous carbon materials. In some embodiments, the anode and cathode electrodes are separated from each other by a porous separator.

In some embodiments, the anode is a composite anode including active materials such as silicon and silicon alloys, and a conductive polymer coating around the active material. The active material may be in the form of silicon particles having a particle size of between about 1 nm and about 100 μm. Other suitable active materials include but are not limited to hard-carbon, graphite, tin, and germanium particles. The polymer coating material can be cyclized using heat treatment at temperatures of from 200° C. to 400° C. to thereby convert the polymer to a ladder compound by crosslinking polymer chains. Specific polymers that can be used include but are not limited to polyacrylonitrile (PAN) where the cyclization changes the nitrile bond (C≡N) to a double bond (C═N). The polymer material forms elastic but robust films to allow for controlled fragmentation/pulverization of silicon particles within the polymer matrix. Additionally, the PAN matrix also provides a path for Li-ion mobility thus enhancing the conductivity of the composite anode. The resultant anode material can overcome expansion and conductivity challenges of silicon-based anodes, such as by providing binders that can prevent expansion of silicon particles and conductive additives to provide a path for Li-ion mobility. In some embodiments, the polymer is about 10 wt. % to 40 wt. % of the anode composite material. Additional description of these Si-PAN composite anodes is provided in U.S. Pat. Nos. 10,573,884 and 10,707,481, both of which are hereby incorporated by reference in their entirety.

The separator for the lithium battery often is a microporous polymer film. Examples of polymers for forming films include polypropylene, polyethylene, nylon, cellulose, nitrocellulose, polysulfone, polyacrylonitrile, polyvinylidene fluoride, polybutene, or copolymers or blends of any two or more such polymers. In some instances, the separator is an electron beam-treated micro-porous polyolefin separator. The electron treatment can increase the deformation temperature of the separator and can accordingly enhance thermal stability at high temperatures. Additionally, or alternatively, the separator can be a shut-down separator. The shut-down separator can have a trigger temperature above about 130° C. to permit the electrochemical cells to operate at temperatures up to about 130° C.

The disclosure will be further illustrated with reference to the following specific examples. It is understood that these examples are given by way of illustration and are not meant to limit the disclosure or the claims to follow.

### Example A—Synthesis of 3,5-Difluorophenyl-Diphenylphosphine Oxide

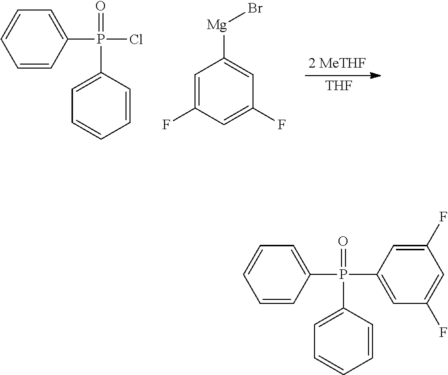

A 250 mL 3-neck round bottom flask equipped with a magnetic stirrer, thermal couple and nitrogen inlet was charged with, 100 mL (10.9 grams) of 3,5-difluorophenyl magnesium bromide. The solution was then cooled to −5° C. To the mixture, diphenyl phosphinic chloride was added dropwise via an addition funnel. The rate of addition was adjusted as needed to keep the temperature of the reaction below 0° C. Addition of the chloride took approximately 20 to 25 minutes and the temperature never rose over −2° C. After addition the ice bath was removed, and the mixture was allowed to stir and slowly come to room temperature (about 1 hour). While stirring at 0° C., thionylchloride was slowly added dropwise by syringe. A maximum exotherm to 15° C. was observed and a white solid precipitate (triethylamine-HCl) quickly formed. When addition was complete, the ice bath was removed. The colorless mixture slowly returned to RT and stirred for 1 hr.

The reaction mixture was transferred to a separatory funnel containing 75 mL of 5% HCl and 75 mL of Ethyl Acetate. Extracted into the organic layer. The aqueous layer was collected and discarded. The organic layer was dried with Magnesium Sulfate and concentrated to a yellow oil.

Dissolved the oil in a mixture of Ethyl Acetate (60%) and Hexanes (40%). Placed on a silica gel column and chromatographed Hexanes/Ethyl Acetate 60% to 70%. Concentrated to a slightly colored solid. Slurred in Hexanes and filtered. Air dried to give 10.9 grams (69%). H+ NMR: (CDCl₃) δ ppm 7.65 (q, 4H), 7.59 (t, 2H), 7.50 (t, 4H), 7.20 (m, 2H), 6.98 (t, 1H). F19 NMR: (CDCl3) δ ppm −107.05 (s, 2F). P31 NMR: (CDCl3) δ ppm 27.51 (s, 1P).

### Example B—Electrolytes for NMC811/Gr Cells

Electrolyte formulations were prepared in a dry argon filled glovebox by combining all the electrolyte components in a glass vial and stirring for 24 hours to ensure complete dissolution of the salts. A functionalized phosphine oxide is added to a base electrolyte formulation comprising a 3:7 by weight mixture of ethylene carbonate, “EC” and ethyl methyl carbonate, “EMC, and 1 M lithium hexafluorophosphate, “LiPF₆”, as a Li⁺ ion conducting salt, dissolved therein. Conventional additives like vinylene carbonate “VC” were added to the base electrolyte composition. Embodiment Example 1 (EE1) uses a representative example molecule as per the present disclosure. The electrolyte components and additives used are summarized in Table A.

### Example C—NMC811/Gr Cell Electrochemical Data

TABLE A
Electrolyte Formulations for NMC811/Gr cells

| | Base | Additive |
|---|---|---|
| Electrolyte | Formulation | Weight (%) |
| Comparative Example 1 | 1.0M LiPF₆ in | VC: 2%, |
| (CE1) | EC:EMC (3:7) | |
| Comparative Example 2 | 1.0M LiPF₆ in | VC: 2%, |
| (CE2) | EC:EMC (3:7) | Triphenylphosphine |
| | | oxide: 1% |
| Embodiment Example 1 | 1.0M LiPF₆ in | VC: 2%, |
| (EE1) | EC:EMC (3:7) | Example A: 1% |

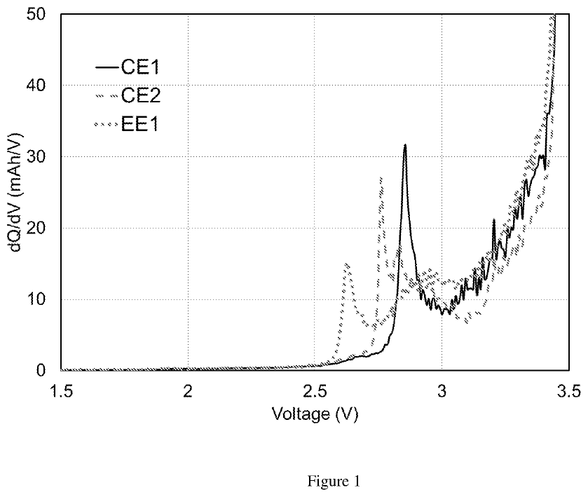

The electrolyte formulations prepared are used as electrolytes in 150 mAh Li-ion pouch cells including lithium nickel manganese cobalt oxide (NMC811) cathode active material and artificial graphite as the anode active material. In each cell, 1.8 mL of electrolyte formulation was added and allowed to soak in the cell for 1 hour. The cells are vacuum sealed, and primary charged before wetting at 25° C. for 10 hours. The cells were then charged to 3.7 V at C/10 rate before degassing, followed by vacuum sealing. After degassing, the cells were charged and discharged twice between 4.2 to 2.7 V at C/10 rate, and the results are summarized in Table B. The AC-IR is the measured internal resistance at 1 kHz, and the reported discharge capacity is for the last first discharge at C/10 rate. The formation dQ/dV profiles are shown in FIG. 1.

TABLE B
Initial Cell Data for NMC811/Gr cells

| | 1^{st} Coulombic | Formation Discharge | |
|---|---|---|---|
| Electrolyte | Efficiency (%) | Capacity (mAh) | AC-IR (mΩ) |
| CE1 | 80.3 | 152.6 | 169 |
| CE2 | 78.5 | 150.6 | 169 |
| EE1 | 81.5 | 151.4 | 183 |

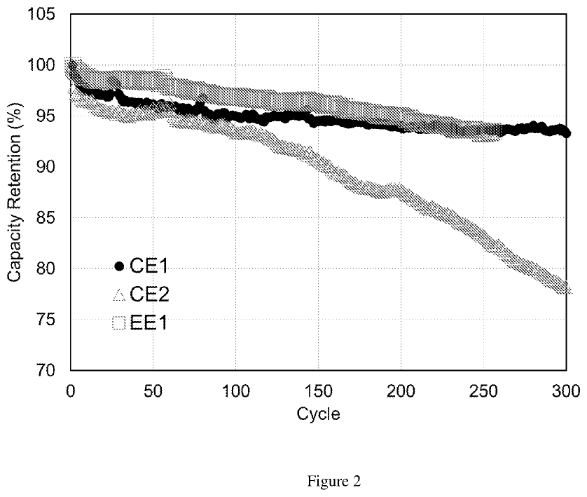

The cells are then charged and discharged 300 times between 4.2 to 2.7 V at 0.3 C rate at 25° C. The relative discharge capacity versus cycle count is displayed in FIG. 2 and summarized in Table C.

TABLE C
Capacity Retention data for NMC811/Gr cells

| | Capacity Retention | Capacity Retention |
|---|---|---|
| Electrolyte | after 100 Cycles (%) | after 250 Cycles (%) |
| CE1 | 94.9 | 93.3 |
| CE2 | 96.9 | 83.2 |
| EE1 | 93.4 | 93.7 |

In FIG. 1 the reduction peaks of the given electrolyte compositions are observed in the cell during the first charge step at C/10 current. CE1 demonstrates a reduction peak at 2.85 V, chiefly understood in the art as correlating with the polymerization of VC. The addition of triphenylphosphine oxide in CE2 results in an additional peak relative to CE1, a reduction peak at 2.76 V. A unique profile relative to both CE1 and CE2 is observed in EE1, with a new peak at 2.62 V as well as an additional peak at 2.95 V. The lower voltage also implies that Example A reduces before VC and triphenylphosphine oxide. This demonstrates that the Example A molecule results in an unexpected SEI forming on the anode surface relative to the comparative examples.

The formation of a different SEI with the embodiment example can also be correlated to the higher AC-IR value for cells with CE2 relative to the comparative examples as shown in Table B. In addition, Table B demonstrates that there is an improvement in the initial coulombic efficiency with EE1 relative to the comparative examples.

The cycle life characteristics as shown in FIG. 2 show that EE1 can outperform both the comparative examples for about 250 cycles through improved capacity retention. The formation of a superior SEI allows for a cell to lose less capacity to reductive side-reactions and thus retain capacity better relative to the comparative examples.

Although various embodiments have been depicted and described in detail herein, it will be apparent to those skilled in the relevant art that various modifications, additions, substitutions, and the like can be made without departing from the spirit of the disclosure and these are therefore considered to be within the scope of the disclosure as defined in the claims which follow.

What is claimed:

1. A composition comprising:
an aprotic organic solvent system;
a metal salt; and
at least one functionalized phosphine oxide or phosphine sulfide according to the following formula: 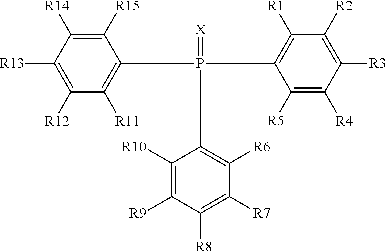
wherein:
X is oxygen or sulfur;
where at least one of R₁ through R₁₅ is independently a C₁-C₁₂ substituted or unsubstituted, saturated or unsaturated alkyl group, or C₆-C₁₄ aryl group, a halogen, an oxygen or sulfur atom, or an oxygen or sulfur atom further bonded to a C₁-C₁₂ substituted or unsubstituted, saturated or unsaturated alkyl group,
wherein any hydrogen or carbon atom can be replaced with an epoxide, halogen, alkyl, alkoxy, perfluorinated alkyl, silyl, siloxy, silane, sulfoxide, amide, azo, ester, carbonyl, nitrile, and thioether group, or combination thereof.

2. The composition of claim 1, wherein the at least one functionalized phosphine oxide or phosphine sulfide is at least one compound selected from 4-fluorophenyl diphenylphosphine oxide, 3,5-difluorophenyl diphenylphosphine oxide, tris(4-fluorophenyl)phosphine oxide, tris(4-fluorophenyl)phosphine sulfide, and mixtures thereof.

3. The composition of claim 1, wherein the at least one functionalized phosphine oxide or phosphine sulfide is present in a concentration of from 0.001 wt. % to 10 wt. % in the electrolyte.

4. The composition of claim 1, wherein the aprotic organic solvent system comprises an open-chain or cyclic carbonate, carboxylic acid ester, nitrite, ether, sulfone, ketone, lactone, dioxolane, glyme, crown ether, siloxane, phosphoric acid ester, phosphite, mono- or polyphosphazene or mixture thereof.

5. The composition of claim 1, wherein the aprotic organic solvent system is present in a concentration of from 60 wt. % to 90 wt. % in the electrolyte.

6. The composition of claim 1, wherein the cation of the metal salt is an alkali metal.

7. The composition of claim 6, wherein the alkali metal is lithium or sodium.

8. The composition of claim 1, wherein the cation of the metal salt is aluminum or magnesium.

9. The composition of claim 1, wherein the metal salt is present in a concentration of from 10 wt. % to 30 wt. % in the electrolyte.

10. The composition of claim 1, further comprising at least one additive.

11. The composition of claim 10, wherein the at least one additive comprises a sulfur-containing compound, phosphorus-containing compound, boron-containing compound, silicon-containing compound, fluorine-containing compound, nitrogen-containing compound, compound containing at least one unsaturated carbon-carbon bond, carboxylic acid anhydride, epoxide, or the mixture thereof.

12. The electrolyte of claim 10, wherein the at least one additive is present in a concentration of from 0.01 wt. % to 10 wt. % in the electrolyte.

13. An electrochemical energy storage device comprising:
a cathode;
an anode;
a separator;
and an electrolyte formulation comprising the composition according to claim 1.

14. The device of claim 13, wherein the cathode comprises a lithium metal oxide, spinel, olivine, carbon-coated olivine, vanadium oxide, lithium peroxide, sulfur, polysulfide, a lithium carbon monofluoride or mixtures of any two or more thereof.

15. The device of claim 13, wherein the lithium metal oxide is LiCoO₂, LiNiO₂, LiNiₓCo_{y}Met_{z}O₂, LiMn_{0.5}Ni_{0.5}O₂, LiMn_{0.1}Co_{0.1}Ni_{0.8}O₂, LiMn_{0.2}Co_{0.2}Ni_{0.6}O₂, LiMn_{0.3}Co_{0.2}Ni_{0.5}O₂, LiMn_{0.33}Co_{0.33}Ni_{0.33}O₂, LiMn₂O₄, LiFeO₂, Li_{1+x′}Ni_{α}Mn_{β}Co_{γ}Met′_{δ}O_{2-z′}F_{z′}, or A_{n′}B₂(XO₄)₃, wherein Met is Al, Mg, Ti, B, Ga, Si, Mn or Co; Met′ is Mg, Zn, Al, Ga, B, Zr or Ti; A is Li, Ag, Cu, Na, Mn, Fe, Co, Ni, Cu or Zn; B is Ti, V, Cr, Fe or Zr; X is P, S, Si, W or Mo; and wherein 0≤x≤0.3, 0≤y≤0.5, 0≤z≤0.5, 0≤x′≤0.4, 0≤α≤1, 0≤β≤1, 0≤γ≤1, 0≤δ≤0.4, 0≤z′≤0.4 and 0≤n′≤3.

16. The device of claim 13, wherein the anode comprises lithium metal, graphitic material, amorphous carbon, Li₄Ti₅O₁₂, tin alloy, silicon, silicon alloy, intermetallic compound, or mixture thereof.

17. The device of claim 16, wherein the anode is a composite anode comprising an active material silicon or silicon alloy and a conductive polymer coating around the active material.

18. The device of claim 17, wherein the conductive polymer is polyacrylonitrile (PAN).

19. The device of claim 13, wherein the device comprises a lithium battery, lithium-ion battery, lithium-sulfur battery, lithium-air battery, sodium ion battery, magnesium battery, lithium/MnO₂ battery, or Li/poly(carbon monofluoride) battery.

20. The device of claim 13, wherein the device is a capacitor or solar cell.

21. The device of claim 13, wherein the device is an electrochemical cell.

22. The device of claim 13, wherein the separator comprises a porous separator separating the anode and cathode from each other.

23. The device of claim 13, wherein the porous separator comprises an electron beam-treated micro-porous polyolefin separator or a microporous polymer film comprising nylon, cellulose, nitrocellulose, polysulfone, polyacrylonitrile, polyvinylidene fluoride, polypropylene, polyethylene, polybutene, or co-polymer or blend of any two or more such polymers.

24. The device of claim 13, wherein the aprotic organic solvent system comprises an open-chain or cyclic carbonate, carboxylic acid ester, nitrite, ether, sulfone, ketone, lactone, dioxolane, glyme, crown ether, siloxane, phosphoric acid ester, phosphite, mono- or polyphosphazene or mixture thereof.

25. The device of claim 13, wherein the aprotic organic solvent system is present in a concentration of from 60 wt. % to 90 wt. % in the electrolyte.

26. The device of claim 13, wherein the cation of the metal salt is an alkali metal.

27. The device of claim 26, wherein the alkali metal is lithium or sodium.

28. The device of claim 13, wherein the cation of the metal salt is aluminum or magnesium.

29. The device of claim 13, wherein the metal salt is present in a concentration of from 10 wt. % to 30 wt. % in the electrolyte.

30. The device of claim 13, wherein the electrolyte further comprises at least one additive.

31. The device of claim 30, wherein the at least one additive comprises a sulfur-containing compound, phosphorus-containing compound, boron-containing compound, silicon-containing compound, fluorine-containing compound, nitrogen-containing compound, compound containing at least one unsaturated carbon-carbon bond, carboxylic acid anhydride, epoxide, or mixture thereof.

32. The device of claim 30, wherein the at least one additive is present in a concentration of from 0.01 wt. % to 10 wt. % in the electrolyte.
